(19) United States
(12) Patent Application Publication
(10) Pub. No.: US 2008/0103794 A1
(43) Pub. Date: May 1, 2008

(54) VIRTUAL SCENARIO GENERATOR

(75) Inventors: Jeffrey W. Pettiross, Lake Forest Park, WA (US); Sean Patrick Nolan, Bellevue, WA (US); Johnson T. Apacible, Mercer Island, WA (US); Cezary Marcjan, Redmond, WA (US); Ivo William Salmre, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/760,218

(22) Filed: Jun. 8, 2007

Related U.S. Application Data
(60) Provisional application No. 60/863,897, filed on Nov. 1, 2006.

(51) Int. Cl. G06Q 10/00; G01C 21/00

(52) U.S. Cl. 705/1; 701/213

(57) ABSTRACT

A virtual scenario generator is provided that applies a virtual scenario to real-world data, such as health and fitness related data, adding a creative way to track the real-world data and/or enhancing the data by adding a competitive element. Thus, the activity related to the real-world data can be incentivized in this regard. A virtual scenario application component can receive data from an input device and apply the virtual scenario, which can be created using an interface, based on rules related to the scenario. The scenario data can subsequently be tracked, on a computer display for example. Additionally, a collaborative functionality can be employed to allow competition between remotely located users of the same virtual scenario, and advertisements can be sent to the users based on many factors including sponsorship and location.

### CROSS-REFERENCE TO RELATED APPLICATION(S)

This application claims the benefit of U.S. Provisional Patent Application Ser. No. 60/863,897 filed on Nov. 1, 2006, entitled “INTERACTIVE AND INTUITIVE HEALTH AND FITNESS TRACKING,” the entirety of which is incorporated herein by reference.

### BACKGROUND

The evolution of computers and networking technologies from high-cost, low performance data processing systems to low cost, high-performance communication, problem solving, and entertainment systems has provided a cost-effective and time saving means to lessen the burden of performing every day tasks such as correspondence, bill paying, shopping, budgeting information and gathering, etc. For example, a computing system interfaced to the Internet, by way of wire or wireless technology, can provide a user with a channel for nearly instantaneous access to a wealth of information from a repository of web sites and servers located around the world. Such a system, as well, allows a user to not only gather information, but also to provide information to disparate sources. As such, online data storing and management has become increasingly popular.

For example, collaborative social networking websites have exploded world-wide. These sites allow users to create remotely stored profiles including personal data such as age, gender, schools attended, graduating class, places of employment, etc. The sites subsequently allow other users to search the foregoing criteria in an attempt to locate other users—be it to find a companion with similar interests or locate a long lost friend from high school. As another more practical example, banking websites offer users the ability to remotely store information concerning bills to be paid. By utilizing this feature, users can automatically schedule bill payments to be made from their bank account which will be automatically debited when the payment is scheduled. This allows simultaneous electronic management of account balancing and bill paying such to save the user from manually entering checks into the register of their checkbook.

Convenience is one reason for the popularity of the aforementioned technologies; however, there are other factors that could be leveraged in this regard. For example, friendly competition is one of the most primal motivators for our kind. This is the reason many of us are drawn to sports (baseball, soccer, tennis, etc.) and other activities (such as singing competitions, science fairs, spelling bees, and the like) that crown someone or some group of people as superior to all others. This desire for competition often drives one to succeed, for example in scholastic and occupational activities as well. For children and adults alike, sometimes adding competition can make even the most mundane tasks somewhat more interesting than without competition. An example of one area that is mundane and boring for many people is fitness.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

A virtual scenario generator that applies a virtual scenario to a set of real-world data is provided to incentivize and/or provide a competitive element to activities to which the real-world data relates. The generator can provide an interface that allows definition of a scenario as well as rules to go along with the scenario. Users can subsequently utilize the scenario to interpret the real world data in a competitive and/or alternative tracking manner. For example, the user can map their fitness activity (running for example) to a virtual run from Seattle to Portland and track their progress on a map or other visual representation based on the real-world running data.

Additionally, a centralized data platform can be utilized to facilitate the foregoing functionality with respect to a plurality of disparately located users. Thus, the data platform can store health and fitness information for the plurality of users, for example, and allow the users to utilize similar scenarios for competition. In this regard, the users can view each other's progress in the virtual scenarios adding a competitive element to the activity being performed. Moreover, advertisements can be implemented throughout the subject matter to allow sponsorship of at least portions of the virtual scenarios. Thus, sponsors can implant ads relating to location or progress of a user in a given scenario and/or offer coupons or other prizes to the contestants.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of an exemplary system that facilitates applying a virtual scenario to data.

FIG. 2 illustrates a block diagram of an exemplary virtual scenario component.

FIG. 3 illustrates a block diagram of an exemplary scenario application component.

FIG. 4 illustrates a block diagram of an exemplary virtual scenario component.

FIG. 5 illustrates a block diagram of an exemplary environment utilizing a virtual scenario component.

FIG. 6 illustrates an exemplary flow chart for applying a virtual scenario to data.

FIG. 7 illustrates an exemplary flow chart for ensuring data conformity with rules of a virtual scenario.

FIG. 8 illustrates an exemplary flow chart for using location in conjunction with a virtual scenario.

FIG. 9 is a schematic block diagram illustrating a suitable operating environment.

FIG. 10 is a schematic block diagram of a sample-computing environment.

### DETAILED DESCRIPTION

A virtual scenario generator is provided to facilitate applying virtual scenarios to real-world activities to provide incentive to perform the real-world activities. As described, friendly competition can be an easy motivator for many people to complete even the most undesirable task. Thus, the subject matter described herein utilizes the worldwide communication technologies of today to apply a competitive virtual scenario to activities incentivizing people to “win” the scenario and complete otherwise uninteresting or undesirable tasks in the first place. It is to be appreciated that the tasks can be interesting and/or desirable, but adding the competitive element of the virtual scenario can make them even more interesting and/or desirable. Thus, a virtual scenario component can be provided that aggregates data relating to a real-world activity and applies at least one virtual scenario to the data. The data can originate from a variety of sources including devices and applications, as will be further described, and/or a platform that houses such data. Additionally, access components and/or routines can be provided to facilitate authorized use of the data for the more serious of scenarios, for example.

In one embodiment, the virtual scenario component can be utilized in conjunction with health and fitness type data to not only incentivize fitness, but also to provide a way of tracking fitness. Thus, the benefit of the disclosed subject matter can be not only to fill incentive and competitive voids, but also to provide tracking of fitness data that can be important to a user's physician and/or personal trainer, for example. As an example, the virtual scenario component can provide a trek from Seattle to Portland in which the user can participate. The trek can be a running expedition, for example, where the user can run around their neighborhood (as part of a daily fitness routine) periodically and enter data regarding the run into an application that can utilize the virtual scenario component. For example, suppose the user ran 5 miles a week for the past week around streets of their neighborhood and entered the mileage data into the application after each run. The user could check status at the end of the week and see on a map, for example, how far they have come and how much longer they have left to go on a virtual run from Seattle to Portland. In this regard, the user can be incentivized to eventually reach Portland (in the virtual sense) and up their running to 7 miles a day and/or the frequency of their running. In another embodiment, the user can be one of many participating in the run to Portland, and is incentivized in this regard to beat the other contestants. Additionally, rewards can be provided for place winners, for example.

In another embodiment, the scenario can be sponsored such that advertisements can be displayed on the application utilized by the user during certain legs of the run, for example. Additionally, the sponsor can provide further incentive such as coupons for merchandise either as motivation to finish a certain leg or distance, or during the run, for example, on a personal device when in proximity to an associated retailer. Further embodiments and aspects of the subject matter will be described below.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

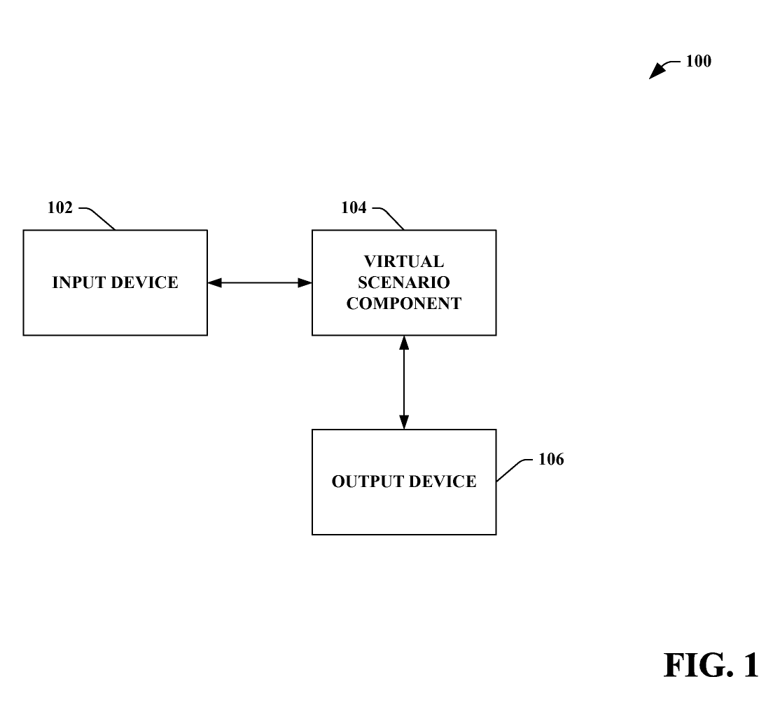

Now turning to the figures, FIG. 1 illustrates a system 100 that facilitates providing a virtual scenario applied to input data. An input device 102 is provided that stores data related to an activity; a virtual scenario component 104 is also provided that can, for example, store and/or generate scenarios that can be applied to data, and an output device 106 is provided that can output at least a portion of scenario information. In one embodiment, the input device 102 can provide input data to a virtual scenario component 104. The virtual scenario component 104 can apply at least one scenario to the data and output the result to an output device 106. It is to be appreciated that the input device and the output device can be the same device and/or components within the same device as well, etc.

For example, the input device 102 can provide data regarding a fitness activity performed by a user of the input device 102. It is to be appreciated that the input device 102 can be an application (such as a software application running on a desktop computer, laptop computer, personal digital assistant (PDA), and the like), a device (such as a personal fitness device including fitness tracking components such as a fitness watch, bicycle computer, pedometer, etc. as well as fitness equipment such as a treadmill, Stairmaster, elliptical trainer, rowing machine, stationary bike, and the like), and/or an application that provides computer connectivity with such devices. Additionally, the applications and/or devices can be Internet-enabled and/or global position system (GPS) enabled to facilitate additional functionalities of the virtual scenario generator as disclosed herein. Thus, the input device 102 can house and provide data such as distance of a run, bike, or similar activity, for example, to the virtual scenario component 104.

The virtual scenario component 104 can, for example, apply a scenario to the data. It is to be appreciated that the scenario can be one previously defined and/or selected by the user, a system default scenario, a scenario created by another user and/or organization (such as a sponsor of an expedition, for example). Additionally the virtual scenario component 104 can manage access, data normalization, and other compatibility tasks with regard to the data from the input device 102. Upon applying the scenario, resulting data, such as all or a portion of data related to the scenario, can be output to the output device 106. This output can be the result of a request made to the virtual scenario component 104, for example, and the output device can be an application as described above and/or a device as described above, and is not so limited to video or display devices, but could be auditory as well such as an alarm on a watch indicating completion of a leg of the applied scenario, for example. As mentioned, the output device 106 can also be the same device (and/or a disparate component within the same device) as the input device 102. It is to be appreciated that the subject matter is not so limited to fitness data and scenarios, rather many real-world scenarios can be incentivized by virtual scenario application. For example, medication consumption can be problematic as far as remembering to actually take the medication at the prescribed times during the day. The virtual scenario component 104 can be used to provide rewards (such as coupons for taking all doses on time) and/or competition based on taking the prescribed medication to add a similar sort of incentive as described herein.

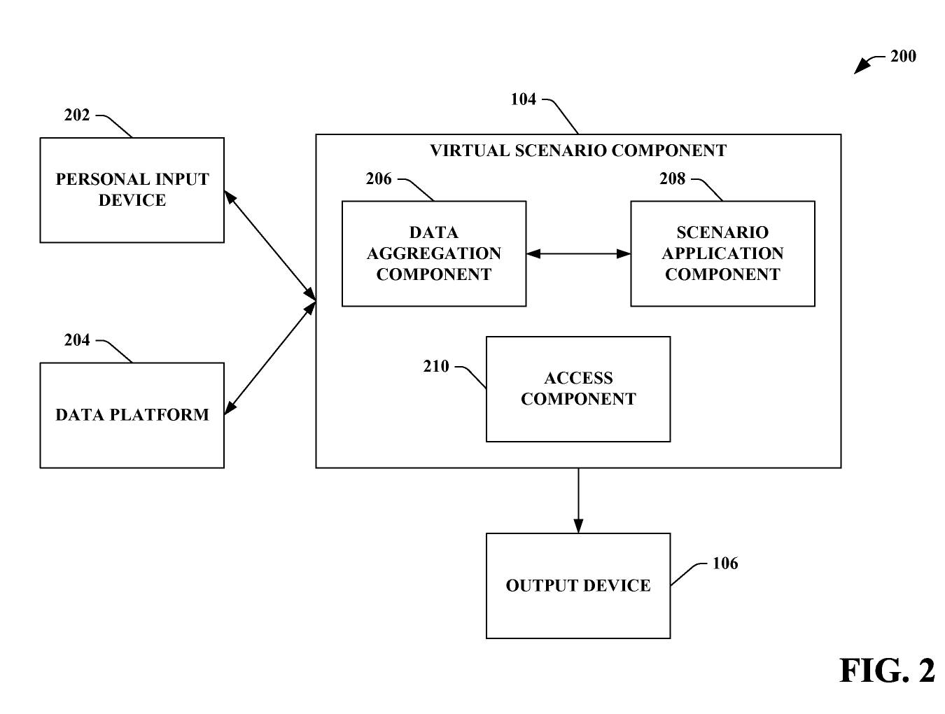

Referring to FIG. 2, a system 200 for utilizing a scenario in conjunction with real data is shown. A personal input device 202 and/or a platform 204 are provided that respectively house and can communicate information relating to real-world data, such as fitness activities. A virtual scenario component 104 is also shown having a data aggregation component 206 that can collect data related to the activity, whether it is of single or multiple instance, and a scenario application component 208 that can apply at least one scenario to the data and can also manage scenario creation and/or selection as well as other tasks associated with managing scenarios. Additionally, the virtual scenario component 104 comprises an access component 210 to manage access to the scenarios and data associated therewith. An output device 106 is also shown to provide data resulting from the application of a scenario to the data to a user, for example.

The personal input device 202 can be, for example, an application and/or device as described supra, that can collect, transmit, receive, and/or display data related to fitness. It is to be appreciated that the personal input device 202 can be an output device, such as output device 106, or a component thereof. Likewise, the output device 106 can be the personal input device 202 and/or a component thereof. Additionally, the data platform 204 can be a central storage for data and provide for storage and access to the data. The data can be, for example, related to personal health and fitness. The virtual scenario component 104 can leverage the data platform 204 to request and/or receive the data regarding health and fitness within the data platform 204; as well, the virtual scenario component 104 can utilize the data platform 204 to store and retrieve information related to the virtual scenarios. It is to be appreciated that devices, such as the personal input device 202 and output device 106, can additionally and/or alternatively utilize the data platform 204 to provide and/or request data to/from the virtual scenario component 104. The virtual scenario component 104 can comprise a data aggregation component 206 that can gather related data to which a virtual scenario is to be applied. For example, the data gathered can be related to similar fitness activities where the virtual scenario is to be applied to the events in their totality, for example, a running expedition to all of the running data. Also, the data gathered can be somewhat different if it is to be applied to a triathlon, for example. Thus, data regarding swimming, running, and biking routines can be gathered and applied to a virtual scenario. It is to be appreciated that data can be gathered automatically and/or specified by the user. It is also to be appreciated that the data aggregation component can also be a part of the scenario application component 208 and vice versa.

A scenario application component 208 is also provided to apply a scenario to the data collected by the data aggregation component 206. The scenario application component 208 can additionally allow users of the system to create and select virtual scenarios to be applied. The data that has been applied to the scenario can be stored and/or output to an output device 106 or a data platform 204, for example. It is to be appreciated that scenarios can be applied as requested and/or automatically as data is received. Thus, the data resulting from application of a scenario can be stored and provided later and/or generated on demand. In any case, the access component 210 can regulate access to the scenario-applied data with respect to the output device 106, for example. It is to be appreciated that the logic and/or rules for authorization to the data can be provided within the access component 210 and/or within a disparate component accessible by the access component 210, such as a data platform 204 for example.

In one embodiment, the data platform 204 can be utilized by an application to store data regarding a daily biking routine, for example. The data can be provided by a bicycle computer (through an application that communicates with the bicycle computer, for example), and the user can request a mapping of a week's worth of bicycle rides to the Tour de France, for example. The data aggregation component 206 can request the plurality of bicycle trip data entries from the data platform 204 and submit them to the scenario application component 208, for example. The scenario application component 208 can have the Tour de France scenario as a useable scenario and can apply the scenario to the data. When the scenario is applied, various data embodiments can be output to the output device 106. For example, a map of the Tour de France can be displayed with the user's progress highlighted. Additionally, a video of the progress and way-points hit can be displayed and/or a preview clip of the way-points to come in future bicycle trips. Moreover, the output device 106 can be the bicycle computer or other personal device and can alert the user to the way-point hit during the actual real-world bicycle trip.

It is to be appreciated that many methods can be used to facilitate this behavior including preloading the bicycle computer with information and using distance information to deduce when the user arrives at the way point, but also the bicycle computer can be Internet-enabled (by cellular technology for example) and can constantly update the scenario application component 208 (or another system that is in constant communication with the scenario application component 208, such as a data platform 204, for example) with distance information. The scenario application component 208 (or a disparate system that is in constant communication, such as a data platform 204) can send, for example, an alert to the bicycle computer that the user has hit the way-point. It is to be appreciated that, in this example, other data such as speed can be employed to provide information about a distance and/or time until the user hits the way-point. Additionally, the user can be one of many participating in the same Tour de France expedition and the access component 210 can only allow the participants to view data regarding their own and other's progress in the expedition. For example, a distance and/or a map showing the progress of a leader can be displayed (e.g. on a bicycle computer and/or other display such as a PC or PDA or rendered as an audio output on a personal device, for example) to incentivize the contestant to catch the leader. It is to be appreciated that the subject matter is not limited to the foregoing and following examples, rather these are just many embodiments that can result from utilizing the subject matter herein described.

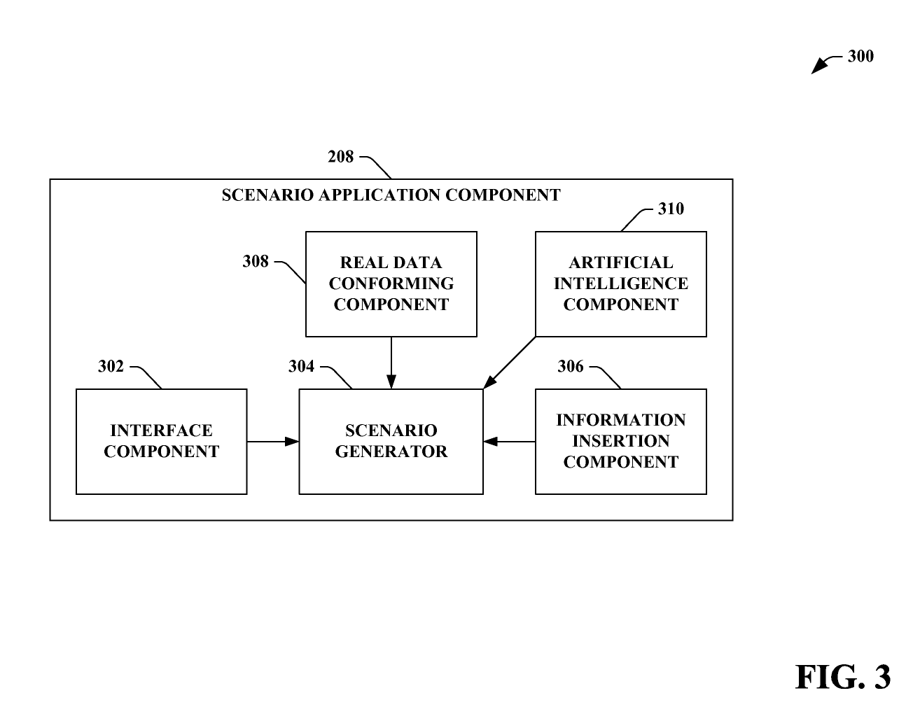

Turning now to FIG. 3, a system 300 that facilitates utilizing a scenario application component is displayed. More particularly, a scenario application component 208 is provided comprising an interface component 302 that can allow a user or application to manage scenarios, a scenario generator 304 that can utilize information provided to generate one or more scenarios to be used in conjunction with the subject matter herein described, an information insertion component 306 that can provide additional information to be utilized in one or more scenarios (such as sponsorship information, for example), a real data conforming component 308 that takes real-world data and provides transformations that may be necessary to conform the data to a given virtual scenario, and an artificial intelligence component 310 that can utilize machine learning to create or change one or more scenario(s).

The interface component 302 can provide for virtual scenario management such as creation of the scenarios. The creation can take on a variety of forms including displaying a map and having a user specify start and end points if the virtual scenario, in the fitness data example. Additionally, way-points can be specified with the same point and click functionality, for example. The start, end, and way points can also be specified by an automatic location device, such as global positioning system (GPS) enabled devices (hand-held devices, cameras, phones, etc.) or other Internet Protocol (IP) location services. The interface component 302 can also provide for specification of the virtual scenario(s) to be applied to real-world data and specify the type of real-world data that is to be used. This also entails specification of acceptable sources of the data if necessary. For example, data can be input via numerous devices and applications as shown above; however, the creator of the virtual scenario can desire to create a strict competition by providing that only data supplied by a trusted source, such as a personal fitness watch, pedometer, etc., can be applied to the scenario. In this regard, for contestants to participate in the scenario, they need to utilize the device specified to record data relevant to the virtual scenario.

For example, a biathlon similar to discussion above can be created as a virtual scenario consisting of biking and running. A user can create this virtual scenario as a bike trip from Cleveland to Boston followed by the Boston Marathon, for example, utilizing the interface component 302; it is to be appreciated that various way-points can be specified as well. This scenario can be an annual prestigious event boasting large cash or merchandise prizes, for example, where trusted data is a necessity to prove the true winner. Thus, the creator of the virtual scenario may want to specify that only data from certified bicycle computers and pedometers is to be accepted in conjunction with the scenario to ensure accuracy and prevent malicious use. Also, certified facilities can be provided as well where other activities are desired; for example, for a triathlon, a swimming facility can be specified where trusted employees of the facility can monitor swimmers and enter trusted data regarding distance (laps, for instance) into an application in communication with the virtual scenario component or a related component. Specifying what types of data are to be accepted (and their originating sources, for example) can be done through the interface component 302 when setting up the scenario. To further the Cleveland to Boston bike ride and Boston Marathon example, contestants nation- and/or world-wide can then begin their virtual scenario by biking. Each contestant can bike to their leisure or to win the competition, and the distance biked can be entered into a platform by the certified bicycle computer, for example, that keeps track of fitness data. Once the biking is completed for a given user, they can begin running (it is to be appreciated that the activities can be performed simultaneously as well). The running data is input by the certified pedometer into a platform, for example. As described above, the platform can be the virtual scenario component or a component associated therewith, also it can be a separate system that is in constant communication with the virtual scenario component. Once someone finishes the scenario, all contestants can be notified, for example, on their personal devices (bicycle computers or pedometers) and/or on other applications and/or devices. It is to be appreciated that other information can be provided as well, such as the current second place contestant's time and/or distance to finish, advertisements, etc. The interface component 302 can be utilized to specify the data that is to be and/or can be sent to or requested by the contestants.

Additionally, an information insertion component 306 is provided to automatically add information and advertisements to given scenarios. In this regard, the subject matter as described can be monetized allowing corporations (or other entities or people) to sponsor the virtual scenarios or a portion (leg) thereof. For example, a local restaurant can sponsor (and/or create) a virtual scenario where advertisements can be displayed to a user in many embodiments, such as where the user is checking progress on a map displayed on a personal computer, or perhaps during activity related to the virtual scenario on a personal device carried by the user. When checking the map, an advertisement for the restaurant can be displayed and/or locations of the restaurant along the virtual route (or on the actual route taken by the user) can be displayed. Additionally, when performing activity related to the virtual scenario (for example running down the user's city streets in participation of the virtual running scenario hosted by the restaurant), advertisement can be sent to the user's personal fitness device used to track progress and communicate information back to the virtual scenario component (and/or platform). Additionally, the virtual scenario component (and/or platform) can send coupons to the personal device, for example, or other indication of promotion.

For example, the user can be running within a proximity of the restaurant and the personal device can be sent an advertisement for a free soft drink. More on this scenario that can help companies build rapport with customers and communities will be discussed in subsequent figures. Thus, the information insertion component 306 can provide additional information to the virtual scenario itself to be rendered in subsequent requests for scenario data, as well as to devices of contestants participating in the scenario in an alert or event type manner, for example. The alerts/events can be according to a position of the device, for example, where the device is GPS-enabled and/or is communicatively coupled to the virtual scenario component 104 or a platform associated therewith, for example. It is to be appreciated that the information inserted by the information insertion component 306 can be done so by the component itself or by leveraging one or more components of the scenario application component 208 or other devices such as the data platform 204 in FIG. 2. The information insertion component 306 can also allow information to be given to users or entities based on location (real location and/or location in the virtual scenario). Furthermore, this can include information created by users such that users who have reached a point in the expedition can leave messages (such as trash-talk or motivating words, for example) to be delivered to other users as they reach the point. Additionally, ads and such can also be inserted into the scenario data in this regards as well to allow, for example, corporations to sponsor different legs of the scenario. For example, Company A can represent the first mile, so where the user is still in the first mile of the expedition, Company A's ads are displayed when tracking progress and/or while performing the fitness activity (such as on a personal fitness device, for example). Then, a different corporation can sponsor the next mile and so on such that the advertising is based on the user's progress. In this regard, ad spots for earlier legs can be monetized differently (more expensive) since they will receive broader coverage, for example.

The real data conforming component 308 can be utilized to transform real data (such as collected by the data aggregation component) into data that applies to the virtual scenario. For example, this can be the component that ensures the data originated from a specified device/application once scenario setup has occurred, as explained above. Additionally, the real data conforming component 308 can be responsible for normalizing data where data originating from different sources can require additional factors to be considered in aggregating the data. For example, running on a treadmill or an elliptical trainer can be much easier than running outdoors; as such, a virtual running scenario can specify transformations such that perhaps 1 mile of elliptical training is equivalent to 1.25 miles of outdoor running. In this regard, data can be normalized by the data conforming component 308 to ensure fairness in competition. Thus, where the elliptical trainer is the source of input for the distance of a participating user, their distance can be discounted according to the transformation. Similarly, altitude can come into play where, for example, running 1 mile up a 10 percent grade hill can be equal to running 0.8 flat miles. It is to be appreciated that such normalization can be specified by the described subject matter automatically, through the interface component 302, and/or as default presets that can be customized or otherwise modified. Also, on the subject of altitude, the fitness activities can include altitude related expeditions such as virtually climbing Mount Everest by climbing indoor mountain climbing walls. Additionally, certified facilities can be specified, as provided above, to ensure accuracy and fairness of the input data if desired. In addition, the facility can be one or more of the sponsors for the event and can create the scenario with the interface component 302 allowing contestants to participate as described herein.

The artificial intelligence component 310 can be used to create data models from aggregated data. The models can be utilized in conjunction with machine learning mechanisms to modify and/or create one or more virtual scenarios. For example, aggregated data can be historical data for a user, the historical data or a model thereof can be analyzed using artificial intelligence to create a scenario for a similar user (in a “people like me” type of functionality for example). Additionally, the historical data model can be used to recommend scenarios for a user and/or to modify a current scenario. In this regard, collaborative filtering of one or more users' historical data can be utilized by the artificial intelligence component 310 to create this functionality; the collaborative filtering combines the users' data to create or modify a scenario to correspond to the users. Moreover, a user can utilize the artificial intelligence to modify a scenario, for example, where the scenario is too difficult or easy for the user. Additionally, the determination of difficulty can be made by the artificial intelligent component 310, for example based on completed scenarios and perhaps a comparison with duration related to the completed scenarios. It is to be appreciated that the artificial intelligence component 310 can take other factors into account when creating and/or modifying a scenario, such as environmental factors, for example, including the user's physical environment, as well as virtual or programmatic environment.

The foregoing components can supply data to a scenario generator 306, for example. The scenario generator 306 can create and/or apply a scenario based at least in part on the information specified by the various components. It is to be appreciated that the scenarios can be stored and/or accessed in a disparate component and authorization can be provided on a number of levels in the disparate component. Additionally, scenarios can be generated and applied in a just-in-time manner such that the data is aggregated and the virtual scenario applied upon request for the scenario data. Also, the virtual scenario can be created and stored as described above where the scenario is applied to the data as the data becomes available. In this embodiment, features such as automatic notification or alerting, for example, of advertisements is easily implemented as the personal fitness devices can communicate position information and/or other data about fitness activities in real-time without having to wait for application of the scenario to the aggregated data. There are appreciable advantages to both implementations.

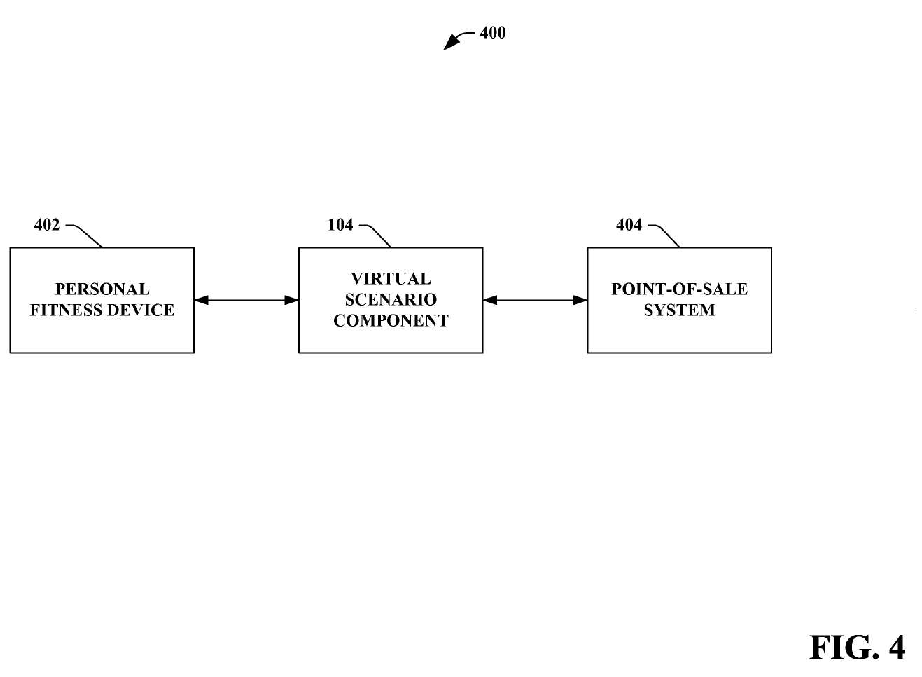

Turning now to FIG. 4, an example 400 system for providing merchandise sponsorship to a virtual scenario/expedition is shown. A personal fitness device 402, such as that described above is provided along with a virtual scenario component 104. Additionally, a point-of-sale (POS) system 404 is provided to facilitate purchasing of promoted products. In one embodiment, the personal fitness device 402 can access an applied virtual scenario in which the user of the personal fitness device 402 is participating. The scenario can detect whether a user's progress has qualified for some free or discounted merchandise and act as a way of proving such. The POS system 404 can be used to purchase the merchandise, apply discount(s), and communicate the purchase back to the virtual scenario component 104 if necessary.

In one embodiment, the personal fitness device 402 is a fitness watch and/or a personal digital assistant (PDA) with GPS capability, for example. The personal fitness device 402 can leverage the virtual scenario component 104 to determine that the user qualifies for a free sports drink based on data relating to the virtual scenario (such as the user has completed 3K of a 5K run sponsored by the sports drink). The virtual scenario component 104 can also determine a proximity of the device to a local convenience store, for example, by the GPS capability of the device. It is to be appreciated that this functionality can be implemented within the device as well and not require use of the virtual scenario component 104. The device can display a coupon for the free sports drink when the user is in proximity. The user can go into the convenience store and present the fitness device, for example, as proof of the coupon. The POS system 404 can process a sale for the fitness drink and contact the virtual scenario component to apply a discount to the drink, for example, and to provide information that the coupon has been exercised and is now void. It is to be appreciated that the personal fitness device can have a mechanism for identification used in this regard (e.g. a bar code on the device or the POS system 404 can cause the device to communicate the purchase back to the virtual scenario component 104).

Additionally, such an embodiment can also be used for redeeming prizes related to scenarios. For example, a scenario like the bike ride/marathon can be initiated as described above and be sponsored by an oil change company and a coffee shop. The top 100 winners by time, for example, can receive a free oil change and a free coffee for being such motivated athletes. Thus, the personal fitness device 402 can be utilized as proof of their winning (e.g. the device can show the coupon along with a bar code, and/or just act as a way to identify the winning contestant as described above). As shown, the POS system 404 can communicate back to the virtual scenario component 104 that the coupon is spent, and/or cause the personal fitness device 402 to otherwise dispose of the coupon.

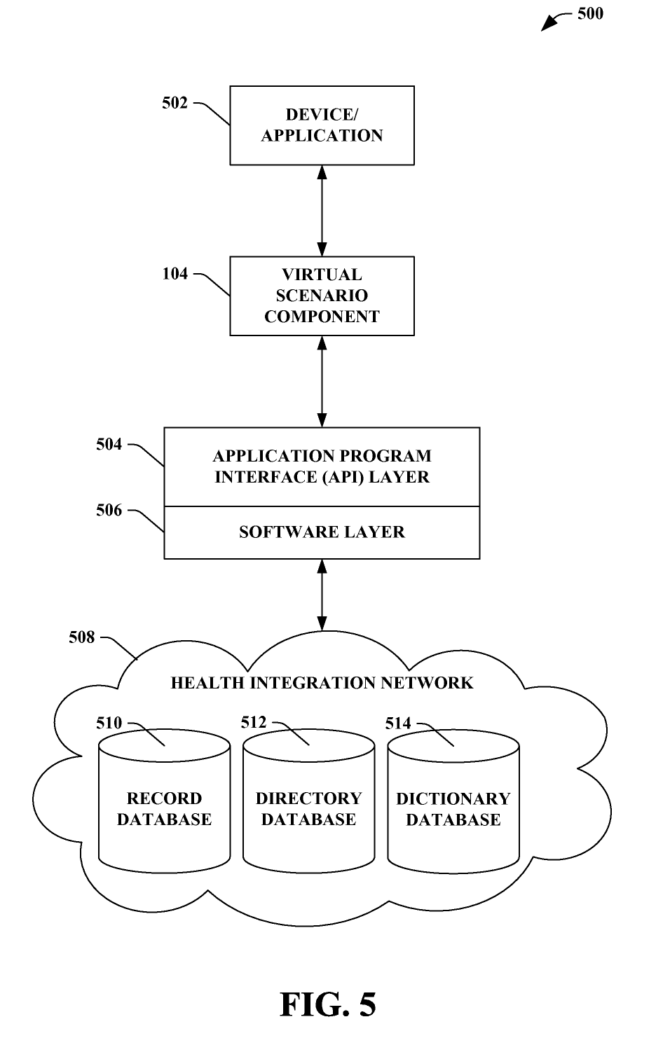

Referring to FIG. 5, an example system 500 that facilitates accessing information within a health integration network and applying a virtual scenario to the data is shown. A device/application 502 can be provided that can request and/or provide data. It is to be appreciated that the device/application 502 can be many different types of applications including software applications, electronic devices executing a software application, electronic devices alone, legacy devices interfaceable with a device executing a software application, and the like. The device/application 502 can utilize a virtual scenario component 104 to request and render data according to a selected virtual scenario to incentivize activities related to the data as described above, for example. Requests to the virtual scenario component 104 can leverage an application program interface (API) 504 to request and store data within a health integration network 508 that can be used in conjunction with the virtual scenario. It is to be appreciated that the API 504 can synchronously or asynchronously communicate with a plurality of virtual scenario components 104 of similar or different types. Additionally, the virtual scenario component 104 can be a portion of the API 504, the software layer 506, and/or the health integration network 508. The API 504 can also have a software layer 506 to leverage in interpreting and processing requests to retrieve or store data. The software layer 506 can be separated out as shown, or it can be integrated within the API 504, the health integration network 508, or both. Upon interpreting and processing a request from the virtual scenario component 104 (that can originate from the device/application 502), the software layer 506 can access the health integration network 508 for necessary data or to store necessary data to fulfill the request. The software layer 506 can also provide value-add to the data such as assembling data from the health integration network 508, applying business models or processes in conjunction with data, caching data, and/or applying transformations or additional information to/with the data. It is to be appreciated that there may be a plurality of APIs 504 and software layers 506 connecting to a centralized health integration network 508, and the centralized health integration network 508 may be a single system or distributed across multiple systems, platforms, and the like. Additionally, a plurality of virtual scenario components 104 can leverage the API 504 (or utilize a software development kit that utilizes the API 504, for example).

The health integration network 508 can comprise a plurality of data stores including a record database 510, a directory database 512, and a dictionary database 514. In addition, the health integration network 508 can comprise many other systems and/or layers to facilitate data management and transfer. Furthermore, the databases can be redundant such that multiple versions of each database are available for other APIs and applications and/or a back-up source for other versions of the databases (to provide redundancy, for example). Additionally, the databases can be logically partitioned among various physical data stores to allow efficient access for highly accessed systems. Moreover, the databases can be hierarchically based, such as XML and/or relationally based. The record database 510 can be highly distributed and comprise personal health related data records for a plurality of users. The records can be of different formats and can comprise many kinds of data (single instance, structured or unstructured), such as plain data, data and associated type information, self-describing data (by way of associated schemas, such as XSL schemas for example), data with associated templates (by way of stylesheets for example), data with units (such as data with conversion instructions, binary data (such as pictures, x-rays, etc.), and the like. Moreover, the record database 510 can keep an audit trail of changes made to the records for tracking and restoration purposes. Additionally, data types or related instances of the foregoing information can be stored in a disparate database such as the dictionary database 514 described infra. The record database 510 can be partitioned, distributed, and/or segmented based on a number of factors including performance, logical grouping of users (e.g. users of the same company, family, and the like).

The directory database 512 can store information such as user account data, which can include user name, authentication credentials, the existence of records for the user, etc. The directory database 512 can also house information about records themselves including the user to whom they belong, where the record is held (in a distributed record database 510 configuration) authorization rules for the records, etc. For example, a user can specify that a spouse have access to his/her fitness related data, but not medical health related data. In this way, a user can protect his/her data while allowing appropriate parties (such as spouse, doctor, insurance company, personal trainer, etc.) or applications/devices (blood pressure machine, pacemaker, fitness watch, etc.) to have access to relevant data. In addition, the directory database 512 can comprise data regarding configuring a device/application 502, and virtual scenario components 104, to interact with the health integration network 508; devices/applications 502 and/or virtual scenario components 104, can be required to register with the health integration network 508, and thus, the device/application 502 and/or virtual scenario component 104 data in the directory database 512 can include the registration information.

The dictionary database 514 can hold information relating to vocabulary definitions used by the health integration network 508 and requesting entities such as the API 504, software layer 506, virtual scenario component 104, and device/application 102. Such definitions can include data type definitions and information on how to display the different data types or transform them. Additionally, the dictionary database 514 can hold information for display layouts and templates, etc. Furthermore, the dictionary database 514 can hold different look-up tables that define codes through the use of standards and the like. For example, the dictionary database 514 can support International Classification of Diseases, ninth revision (ICD-9) released by the National Center for Health Statistics. These codes identify different diseases and diagnoses; thus a doctor can put one of these codes on a user's chart in the health integration network 508, and the dictionary database 514 can allow the software layer 508 (or API 506, virtual scenario component 104, and/or device/application 502) to translate this code into something that makes more sense to the user, such as medical name and/or different, other, or additional information concerning the diagnosis. The dictionary database 514 can also be used to retrieve other metadata such as plural and abbreviated forms of codes (such as ICD-9 codes). It can also hold information that allows conversion between different measurement units, such as between feet to meters, Fahrenheit to Celsius, pounds to kilograms, etc. For example, the dictionary database 514 can also hold values for the self-describing rendering information as described above (including XML code, object-oriented code, pseudo-code, XSL, etc.).

In one embodiment, the device/application 502, which can be more than one application, device, and/or user utilizing a graphical user interface (GUI) for example, can make a call to the virtual scenario component 104 to request data regarding a virtual scenario. The virtual scenario component 104 can then request and aggregate relevant data from the API 504, for example. The API 504 leverages the software layer 506 to process the call made by the virtual scenario component 104. The software layer 506 can then query its own internal cache or the health integration network 508 for desired data; additionally or alternatively, the software layer 506 can directly query one or a plurality of the databases 510, 512, and 514 for the desired data. The software layer 506 can serially or asynchronously query for data until all data is obtained from the health integration network 508. The software layer 506 can then manipulate portions of the data using other data it has obtained to formulate the result desired by the virtual scenario component 104 (and/or device/application 502) and return that result to the virtual scenario component 104 via the API 504. The virtual scenario component 104 can then render the data, using the methods described supra, for output to the device/application 502 as requested. It is to be appreciated that the data aggregated by the virtual scenario component 104 can be data regarding activities, and also data regarding the specifics of the requested scenario. Also, as described previously, the virtual scenario component 104 can utilize the API 504 and/or software layer 506 to store scenario information in the health integration network 508 for later use. The data can be that resulting from applying the scenario to the activity data and/or general information regarding the nature of a stored scenario (such as configuration data, and the like).

For example, a device/application 502 can be a GPS enabled device that can track fitness activity related information, such as biking. The GPS device can discern the information about the activity by using GPS coordinates and measuring distance and time to get from one position to the next as well as a map to compensate for grade and curvature of roads, for example. The device/application 502 can desire to retrieve current scenario information and can leverage the virtual scenario component 104 to retrieve the information. The virtual scenario component 104 upon receiving a request from the device/application 502 can utilize the API 504 to request data from the health integration network 508. The information requested can relate to previous virtual scenario information stored, for example, as well as data related to the current and previous bike rides that are to relate to the scenario. The API 504 can utilize the software layer 506 to gather the data from the health integration network 508 where the data can be stored in at least one of the multiple databases 510, 512, and 514. The API 504 can return the information to the virtual scenario component 104 upon receiving response from the software layer 506, and the virtual scenario component 104 can apply the scenario and/or additional information as described supra to the data. Then, the data can be sent to the device/application 502 and displayed to the user. As mentioned, the data can be many things related to the bike ride, such as position of other users displayed on a map if the scenario is a competition, for example. The map can be a local map or a map of the scenario (such as the roads used in the Tour de France).

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent, for instance by inferring actions based on contextual information. By way of example and not limitation, such mechanism can be employed with respect to generation of materialized views and the like.

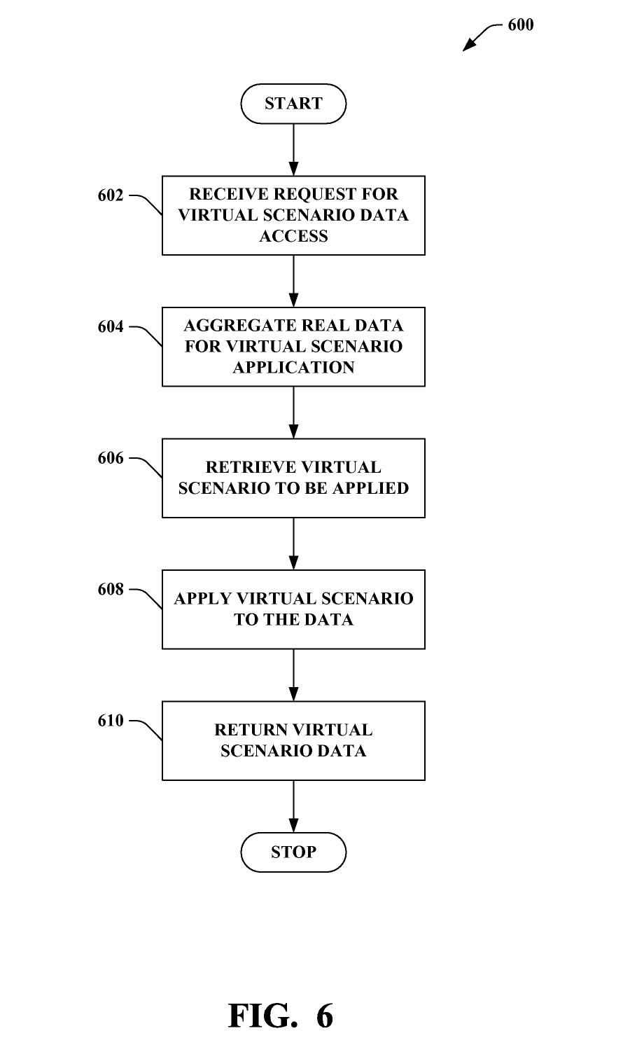

In view of the exemplary systems described supra, methodologies that may be implemented in accordance with the disclosed subject matter will be better appreciated with reference to the flow charts of FIGS. 6-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 6 shows a methodology 600 for applying a virtual scenario to real data. As described above in one embodiment, the data can be related to a health and fitness platform/application and more specifically to a system that facilitates fitness activity tracking. Utilizing the method, at least one virtual scenario can be applied to the real fitness data to encourage further activity and/or competition between contestants of a virtual scenario. At 602, a request for virtual scenario data access is received. This request can be to apply a virtual scenario to some data and/or store data according to a virtual scenario and the like. For example, a user can desire to apply a Boston Marathon scenario to their real running data to track how long it takes them to finish the marathon and/or how many marathons they can finish in a month/year/etc. It is to be appreciated that the scenario chosen can be one created by another user, one that is a system default, one that the requesting user created (through clicking start/end/way points on a map, for example) and/or a combination of one or more of these. At 604, then, the real data that is to be applied to the scenario is aggregated, for example, the user can specify all activity in a certain timeframe, like categories of activity, etc. In the example above, the user can specify all runs they went on in the last month. Additionally, the user can choose to upload current data to an already existing and tracked scenario; as mentioned above, this data can come from a personal fitness device such as a pedometer, for example. Alternatively, the user can be requesting to view data related to a scenario, such as historical data, to see how far they have come in the scenario, for example. In this example, if the virtual scenario is generated in a just-in-time fashion, the real data that applies to the scenario is retrieved in this step and the scenario will subsequently be applied.

At 606, the virtual scenario to be applied is retrieved and as mentioned above, this can be one created by the user, by another user, etc. It can also be one created by a corporation sponsoring a virtual fitness event. For example, a retail store can sponsor a charity run and create a virtual scenario to coincide with the run (for example, the run can have an entry fee as well). Users can join the scenario after it is created and apply it to their exercise data. In one embodiment, the sponsor can leverage this system to place advertisements within the scenario such that they are displayed at multiple stages and in multiple permutations relating to the scenario. For example, the ads can be displayed when users are checking progress of their runs in the overall scenario after certain legs of the scenario are completed, for example (as well as others progress if competitive); additionally, the ads can be sent to personal fitness devices triggered by proximity to a store of the sponsor's or a store selling a product manufactured by the sponsor, for example. In another embodiment, users can place messages or other information at locations of the virtual scenario and this information can be inserted into the virtual scenario such that it is applied to the data as well. At 608, this data, as well as the progress data can be applied to the run, and returned to the requesting application at 610. In one embodiment, the data requested can also be to check other contestants progress in the virtual scenario; in this way, the competitive factor is added to incentivize performing the fitness tasks. Moreover, the subject matter described herein is not only a way to motivate fitness activity, but a convenient and enjoyable way to track the activity as well.

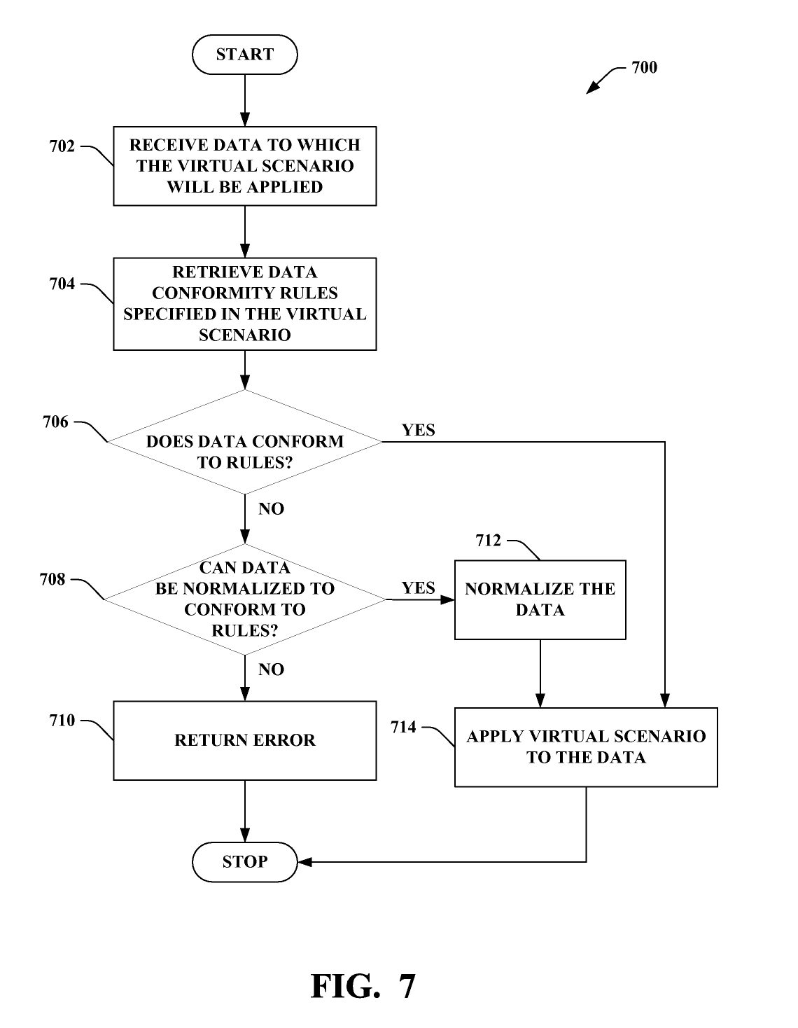

FIG. 7 illustrates a methodology 700 that facilitates regulating data to which a virtual scenario is applied is shown. At 702, the data to which the virtual scenario is to be applied is received. As discussed supra, this data can be personal fitness related data such as a week's worth of fitness activities. At 704, data conformity rules that apply to the requested scenario are retrieved. Upon creating a virtual scenario (using the interface in previous figures for example), rules can be specified regarding the real data, such as allowed/disallowed sources of data for a given scenario. As discussed earlier, this can facilitate restricting competitions having large cash prizes to using official data, for example. Additionally, this can be used to normalize data from various sources; for example, discounting elliptical trainer distance for a virtual scenario pertaining to running. This allows broad participation in the virtual scenarios as well as fairness to all individuals involved. At 706, the real data is checked for conformity with the scenario rules. If the data is conformant, then the virtual scenario is applied to the data at 714. As an example, rules can be provided to regulate the source of the data; for example a bicycle computer can be certified by the promoters or creators of the scenario and for a bicycling event or leg of a scenario, the creator of the scenario can restrict data that can be applied to the scenario to only data originating from the bicycle computer. In addition, perhaps a manufacturer of bicycle computers is hosting the competition and may restrict the data entry to computers of its brand to promote further purchasing of the branded computer.

If the data does not conform to the rules, then at 708, the data is checked with the scenario rules to see if it can be translated to conform to the rules. As mentioned above, perhaps the contestant in a scenario recorded some elliptical trainer or treadmill time and wants to apply it to a virtual running scenario (Boston Marathon, for example). Though the data is not ‘running’ data such as from a pedometer, the creator of the scenario can specify to accept elliptical data at a discounted distance (for example, 1.25 miles of elliptical for 1 mile of running). It is to be appreciated that the distance can also be compounded, for example in a treadmill scenario where the contestant was running at a 20% grade (which can be more difficult than running on a flat grade outdoors). If the data can be conformed according to the scenario rules, then translation is applied and data is normalized at 712. Subsequently, the data is applied in the virtual scenario at 714. If the data cannot be normalized, for example if the competition is extremely strict and calls for true runners only, an error can be returned at 710.

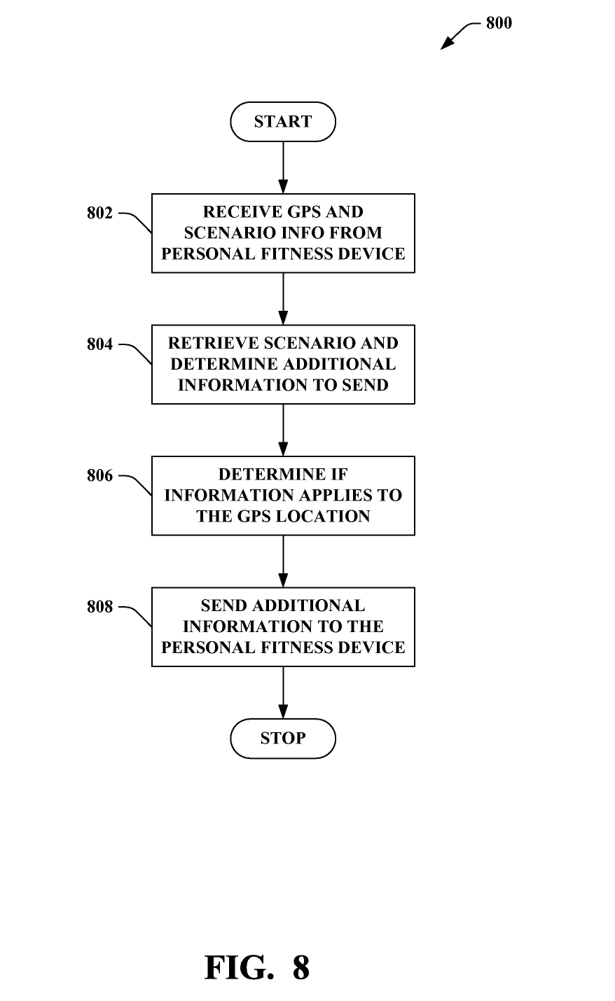

FIG. 8 shows a methodology 800 for submitting information to a personal fitness device in accordance with the described subject matter. At 802, information is received regarding a personal fitness device, such as a participating scenario and/or identifier of the device that can be linked to a user and scenario determined from the user's profile for example, as well as a location specified by GPS (or similar tracking) technology on the personal fitness device, for example. At 804, the virtual scenario can be retrieved when determined. It is to be appreciated that the scenario can be a bare scenario that associates real data in a just-in-time fashion (as an overlay for example). Additionally, the scenario can already be associated with and comprise the associated data such that additional data can be supplied to the scenario and the scenario stores the additional data keeping itself updated. Thus, when the scenario is retrieved, if it is a just-in-time implementation, real data pertaining to the individual user's progress can be associated with the scenario to determine there is information that can be submitted to the user at 806; for example information that applies to the GPS location sent. If the data is already associated and the virtual scenario is a self-contained data instance, this determination takes a lot less work and can even be a boolean indicator of available information for sending, for example. At 806, the information can be related to the GPS location such that, for example, according to the users position, the data can apply. For example, if the data relates to a restaurant, data can be available which relates to a location of the restaurant (such as ads and coupons) to which the device (and hence the user) is in close proximity. At 808, such information can be sent to the fitness device. It is to be appreciated that the data can be many forms of data associated with an establishment and/or location, and the data can relate to a location in the virtual scenario as well as the actual location. Additionally, perhaps the data is something requested by the user. For example, the user can specify a lookup before running for locations of a restaurant near the user's residence. Then when the user goes for a jog or bike ride, the personal fitness device can notify the user if they come within proximity of the restaurant.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

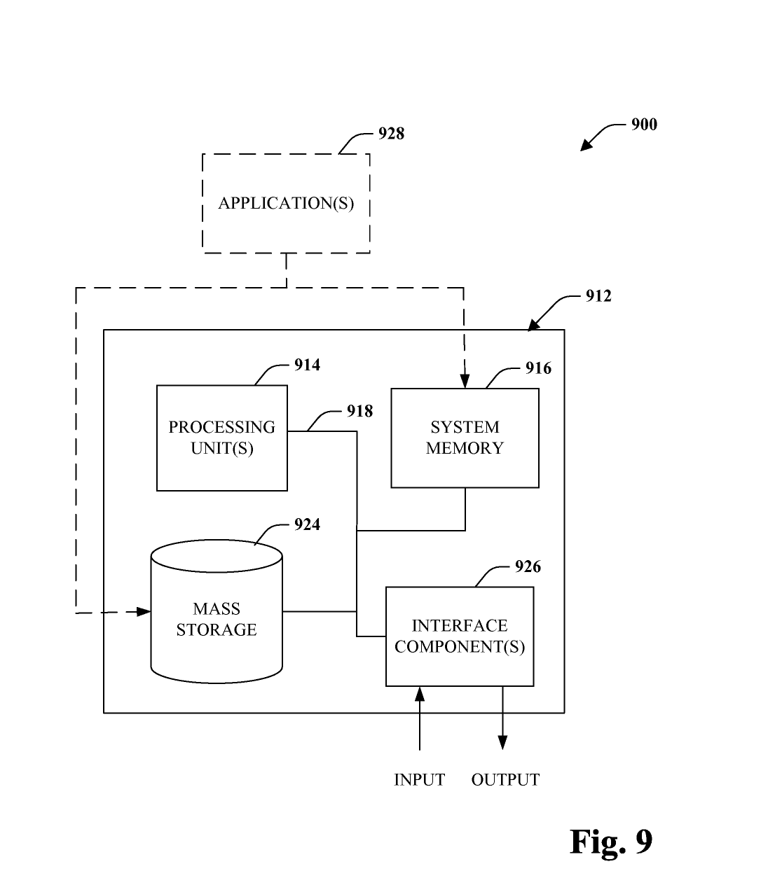

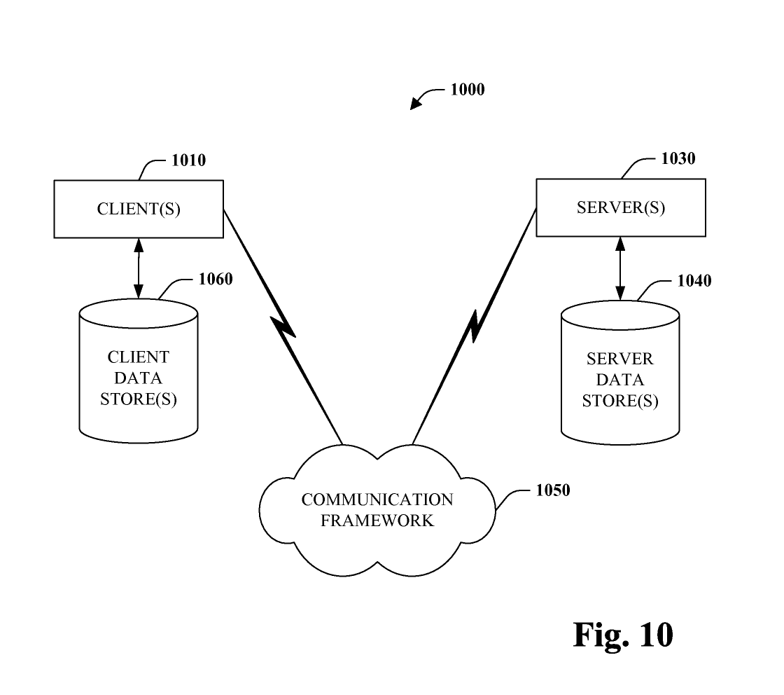

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 900 for implementing various aspects disclosed herein includes a computer 912 (e.g., desktop, laptop, server, hand held, programmable consumer or industrial electronics . . . ). The computer 912 includes a processing unit 914, a system memory 916 and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory or memory stick. In addition, mass storage 924 can include storage media separately or in combination with other storage media.

FIG. 9 provides software application(s) 928 that act as an intermediary between users and/or other computers and the basic computer resources described in suitable operating environment 900. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. Here, the client(s) 1010 can correspond to program application components and the server(s) 1030 can provide the functionality of the interface and optionally the storage system, as previously described. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

By way of example, a personal fitness device or a fitness tracking application in accordance with the subject matter as described herein can be executed on or as a client 1010. The device can request and/or receive fitness tracking data and/or virtual scenario sponsor data one or more servers 1030 (which executes a virtual scenario component) over the communication framework 1050. The server(s) 1030 can obtain the desired data from a data store 1040 or a plurality of data stores (such as a portion of a health integration network). Subsequently, the client(s) 1010 can display the requested or received data such that the user can value the data and/or store the data within the server(s) 1030.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system for applying virtual scenarios to real-world fitness activities, comprising:
a data aggregation component that collects data related to at least one real-world fitness activity; and
a scenario application component that applies at least one virtual scenario to the data such that real-time physical characteristics of the data are displayed in a progress indication related to the virtual scenario, the scenario application component provides remote access to the progress indication.

2. The system of claim 1, further comprising a data input component that receives the data.

3. The system of claim 2, the data input component receives the data from a personal fitness tracking device.

4. The system of claim 2, the data input component receives GPS coordinates from a GPS-enabled device, the GPS coordinates represent a portion of the data.

5. The system of claim 1, further comprising a data conforming component that conforms the data to a format that complies with the virtual scenario.

6. The system of claim 5, the data conforming component normalizes the data to conform to at least one rule specified in the virtual scenario.

7. The system of claim 6, the data is normalized based at least in part on a difficulty difference of the real-world fitness activity as compared to a difficulty of the virtual scenario.

8. The system of claim 1, further comprising an information insertion component that inserts additional information within the virtual scenario based at least in part on the progress indication.

9. The system of claim 8, the additional information is at least one advertisement related to a sponsor of the virtual scenario.

10. The system of claim 1, further comprising an interface component that facilitates generating the virtual scenario based on at least one start point and at least one end point specified on a provided map.

11. A method for applying a virtual scenario to real-world fitness data, comprising:
creating a virtual scenario by specifying start and end points on a provided map;
applying real-world fitness data to the virtual scenario; and
tracking progress of completion of the virtual scenario as a function of the real-world fitness data.

12. The method of claim 11, further comprising sending an advertisement based at least in part on the progress.

13. The method of claim 12, the advertisement is indicative of a sponsor of a potion of the virtual scenario to which the progress relates.

14. The method of claim 11, further comprising creating at least one rule for the virtual scenario that regulates application of the real-world fitness data.

15. The method of claim 14, the rule specifies at least one acceptable input device for the real-world data.

16. The method of claim 14, further comprising normalizing the real-world data to conform to the rule.

17. The method of claim 11, the start and end points are specified by an automated location device.

18. The method of claim 11, further comprising sharing the progress with disparate remotely-located users of the same virtual scenario.

19. A system for applying a virtual scenario to real-world data, comprising:
means for specifying a virtual scenario;
means for receiving data related to at least one real-world fitness activity;
means for applying the virtual scenario to the data; and
means for tracking progress on the virtual scenario as a function of the data.

20. The system of claim 19, further comprising means for displaying advertisements during progress tracking based at least in part on the tracked progress in the virtual scenario.
